(19) United States
(12) Patent Application Publication
(10) Pub. No.: US 2008/0090079 A1
(43) Pub. Date: Apr. 17, 2008

(54) High-resistivity magnetic film from nano-particle plating

(76) Inventors: Arnel M. Fajardo, Beaverton, OR (US); Chang-Min Park, Portland, OR (US)

Correspondence Address: INTEL/BLAKELY, 1279 OAKMEAD PARKWAY, SUNNYVALE, CA, 94085-4040, US

(21) Appl. No.: 11/540,992

(22) Filed: Sep. 28, 2006

(51) Int. Cl. B32B 15/00; B32B 5/16; B05D 1/18

(52) U.S. Cl. 428/402; 428/692.1; 427/437

(57) ABSTRACT

An embodiment of the present invention is a technique to fabricate a device having a magnetic material. A nano-particle colloid is formed in a plating bath of an aqueous solution. The nano-particle colloid has magnetic nano-particles made of magnetic ferrite material. A seed layer is deposited on a substrate. A composite film containing the magnetic nano-particles is deposited on the seed layer using the plating bath.

### BACKGROUND

1. Field of the Invention

Embodiments of the invention relate to the field of semiconductor, and more specifically, to semiconductor fabrication.

2. Description of the Related Art

On-chip devices such as voltage regulators have become increasingly popular in applications requiring low power, high frequency, and efficiency. Typically, these devices use magnetic material targeted for high frequency applications. One major problem with the design of on-chip devices is degraded efficiency or power loss from eddy currents at high frequency.

Existing techniques in the fabrication of magnetic components in high frequency on-chip devices have a number of drawbacks. One technique uses a continuous magnetic layer. This technique produces a large eddy current which leads to high power loss. Another technique uses granular magnetic particles to reduce the eddy currents. However, this technique does not allow subsequent processing such as metallization. Other techniques use materials such as Physical Vapor Deposition (PVD) cobalt-zirconium-tantalum (CoZrTa) alloy or electroless Cobalt Tungsten Boron Phosphorous (CoWBP). These materials have low resistivities in the range of 100-140 μΩ·cm. The low resistivity leads to high power loss due to eddy currents.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system in which one embodiment of the invention may be practiced.

FIG. 2 is a diagram illustrating a voltage regulator according to one embodiment of the invention.

FIG. 3 is a diagram illustrating an inductor circuit according to one embodiment of the invention.

FIG. 4 is a flowchart illustrating a process to fabricate an inductor according to one embodiment of the invention.

FIG. 5 is a flowchart illustrating a process to form a nano-particle colloid according to one embodiment of the invention.

FIG. 6 is a flowchart illustrating a process to deposit a composite film according to one embodiment of the invention.

### DESCRIPTION

An embodiment of the present invention is a technique to fabricate a device having a magnetic material. A nano-particle colloid is formed in a plating bath of an aqueous solution. The nano-particle colloid has magnetic nano-particles made of a magnetic ferrite material. A seed layer is deposited on a substrate. A composite film containing the magnetic nano-particles is deposited on the seed layer using the plating bath.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

An embodiment of the present invention is a technique to fabricate a composite film for use in a device or a component that uses a magnetic material such as an inductor. Nanometer-sized particles of magnetic ferrites are used to increase the electrical resistivity of electroless or electroplated magnetic metal alloy films, while reducing dilution of the overall magnetic properties. These magnetic nanoparticles are incorporated into the plated metal film matrix during plating. The increased electrical resistivity results in reduced power loss from eddy currents at high frequency operation.

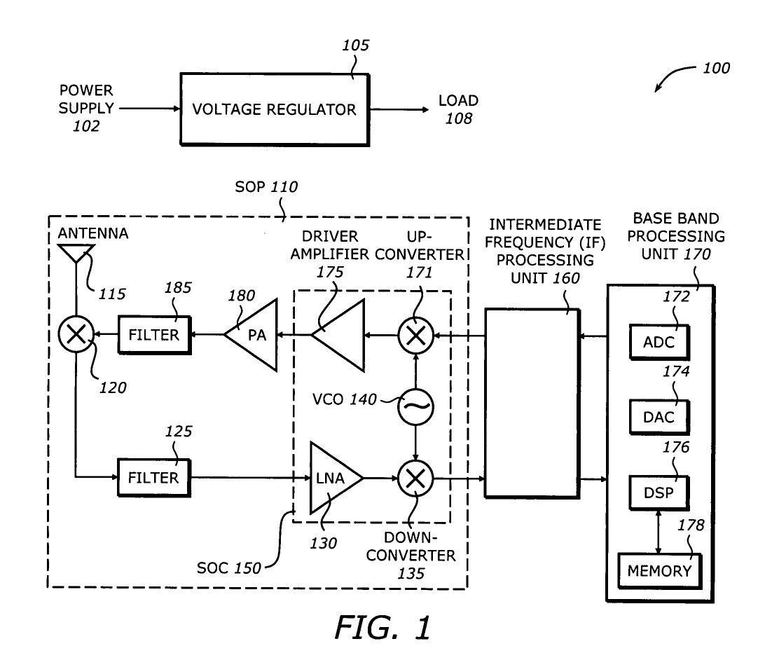

FIG. 1 is a diagram illustrating a system 100 in which one embodiment of the invention may be practiced. The system 100 represents a mobile communication module. It includes a voltage regulator 105, a system on package (SOP) 110, an intermediate frequency (IF) processing unit 160, and a base-band processing unit 170.

The voltage regulator 105 may be an on-chip device. It receives power from a power supply 102 and delivers the power to a load 108. The load 108 may include all the units or devices in the system 100 or a portion of the system 100. The voltage regulator 105 regulates the voltage for the load 108 in response to fluctuations in power consumption of the load 108. The voltage regulator 105 may be part of the SOP 110, the IF processing unit 160, the base-band processing unit 170, or any combination of these. It may be fabricated on-chip or on-die in the same wafer with any of these units or any device in these units.

The SOP 110 represents the front end processing unit for the mobile communication module. It is a transceiver incorporating on-package integrated lumped passive components as well as radio frequency (RF) components. It includes an antenna 115, a duplexer 120, a filter 125, a system-on-chip (SOC) 150, a power amplifier (PA) 180, and a filter 185.

The antenna 115 receives and transmits RF signals. The RF signals may be converted to digital data for processing in subsequent stages. It may be designed in compact micro-strip and strip-line for L and C-band wireless applications. The duplexer 120 acts as a switch to couple the antenna 115 to the receiver and the transmitter to the antenna 115. The filters 125 and 185 may be C-band LTCC-strip-line filter or multilayer organic lumped-element filter at 5.2 GHz and narrowband performance of 200 MHz suitable for the Institute of Electrical and Electronic Engineers (IEEE) 802.11 wireless local area network (WLAN). The SOC 150 includes a low noise amplifier (LNA) 130, a down converter 135, a local voltage controlled oscillator (VCO) 140, an up converter 171, and a driver amplifier 175. The LNA 130 amplifies the received signal. The down converter 135 is a mixer to convert the RF signal to the IF band to be processed by the IF processing unit 160. The up converter 171 is a mixer to convert the IF signal to the proper RF signal for transmission. The VCO 140 generates modulation signal at appropriate frequencies for down conversion and up conversion. The driver amplifier 175 drives the PA 180. The PA 180 amplifies the transmit signal for transmission.

The IF processing unit 160 includes analog components to process IF signals for receiving and transmission. It may include a band-pass filter and a low pass filter at suitable frequency bands. The filter may provide base-band signal to the base-band processing unit 170. The base-band processing unit 170 may include an analog-to-digital converter (ADC) 172, a digital-to-analog converter (DAC) 174, a digital signal processor (DSP) 176, and a memory device 178. The ADC 172 and the DAC 174 are used to convert analog signals to digital data and digital data to analog signal, respectively. The DSP 176 is a programmable processor that may execute a program to process the digital data. The DSP 176 may be coupled to the front end processing unit via the IF processing unit 160 and/or the base-band processing unit 170 to process the digital data. The memory device 178 may contain code and/or data used by the DSP 176.

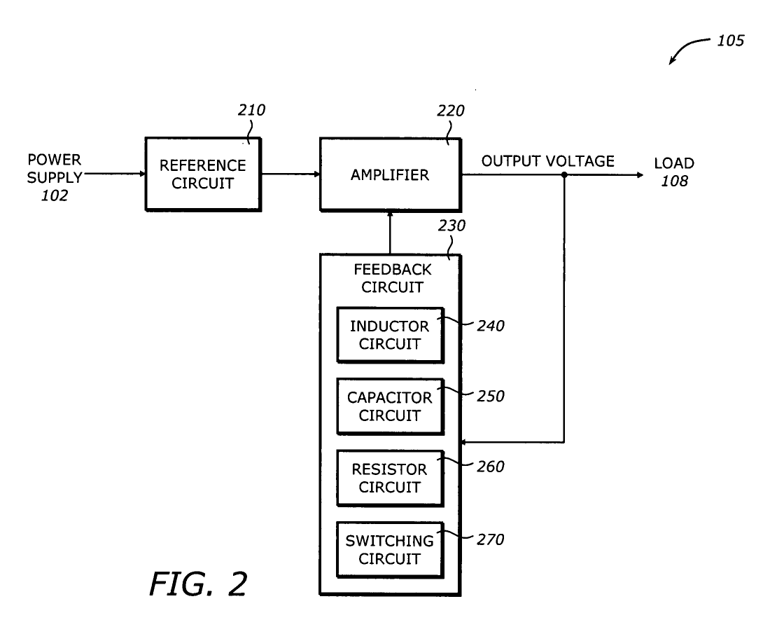

FIG. 2 is a diagram illustrating the voltage regulator 105 shown in FIG. 1 according to one embodiment of the invention. The voltage regulator 105 may be fabricated on-chip with any of the devices or units shown in FIG. 1. For example, it may be fabricated in the same wafer that contains the circuits of the SOC 150. The voltage 105 may include a reference circuit 210, an amplifier 220, and a feedback circuit 230.

The reference circuit 210 receives the input voltage from the power supply 102. This input voltage may be a varying voltage within a specified range. The reference circuit 210 provides a reference voltage to the amplifier 220. The amplifier 220 regulates the output voltage to the load 108 based on the reference voltage and the output of the feedback circuit 230. The amplifier 220 may be a comparator to compare the feedback voltage from the output of the feedback circuit 230 with the reference voltage. The output of the amplifier 220 may control a switching element (e.g., a transistor) to adjust the output. The feedback circuit 230 receives the output voltage to the load 108 and performs some filtering operations such as removing high frequency noise components. The feedback circuit 230 may include an inductor circuit 240, a capacitor circuit 250, a resistor circuit 260, and a switching circuit 270. The switching circuit 270 may include switching elements such as transistors to connect elements within the feedback circuit 230. For example, a terminal of a transistor may be connected to the output of the amplifier 220 so that the transistor may be turned on or turned off depending on whether the reference voltage is smaller or larger than the feed back voltage. The other terminal of the transistor may be connected to the output and to the load through the inductor circuit 240, the capacitor circuit 250, and the resistor circuit 260. The inductor circuit 240 may be fabricated together with the other circuits in the same wafer.

The inductor circuit 240, the capacitor circuit 250, and the resistor circuit 260 may form a filtering network that filters the output voltage to the load 108. The inductor circuit 240 may include one or more inductors which may be fabricated on-chip together with other components or devices. The conductor part in the inductor circuit 240 may define a signal path along which the current may flow to generate an electromagnetic field. The conductor may be shaped in any appropriate shape and may have multiple turns. Each turn may have a spiral, circular, hexagonal, or rectangular shape.

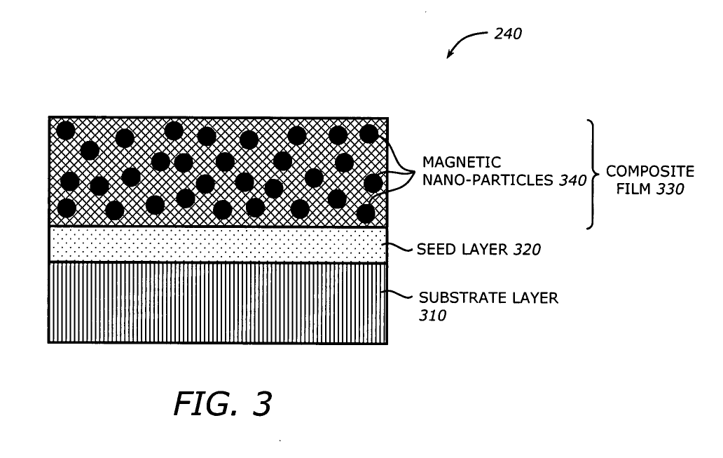

FIG. 3 is a diagram illustrating the inductor circuit 240 shown in FIG. 2 according to one embodiment of the invention. The inductor circuit 240 includes a substrate layer 310, a seed layer 320, and a composite film 330. Note that the inductor circuit 240 may include more or less than the above components.

The substrate layer 310 may be made from any suitable semiconductor material such as silicon (Si), germanium (Ge), or gallium arsenide (GaAs). The substrate layer 310 may contain conductors or interconnect pattern of metal lines.

The seed layer 320 may be made of copper (Cu), palladium (Pd), cobalt (Co), gold (Au), nickel (Ni), or NiFe alloy. It is used to provide an initiation source for the electroless deposition, or to provide electrical contact for the electro-plating, during the formation of the composite film 330. The seed layer 320 may be part of the composite film 330.

The composite film 330 may be a plated metal alloy (e.g., CoWBP) having magnetic nano-particles 340 embedded therein. The magnetic nano-particles 340 may be made of a magnetic ferrite material such as Fe₂O₃, CuFe₂O₄, CuZnFe₂O₄, or NiZnFe₂O₄. The magnetic nano-particles 340 may form a nano-powder with fine particles having diameters less than 100 nm, typically in the range of 25 nm. The composite film 330 helps increase the electrical resistivity significantly while maintaining magnetic properties for high frequency applications. In one embodiment, the electrical resistivity may be in the range of more than 20,000 μΩ·cm. For a composite film having CoWBP and Fe₂O₃, the electrical resistivity may be approximately 40,000 μΩ·cm, which may be translated to eddy current losses of less than 0.1% for an integrated voltage regulator. As a comparison, a composite film having only CoWBP may have an electrical resistivity of only about 140 μΩ·cm, which may result in a power loss of approximately 13%. Another advantage of using the magnetic ferrite material is that the deposition rate of the composite film is increased. For example, without Fe₂O₃, the deposition rate of the electroless CoWBP may be about 0.02 em/minute, whereas the addition of Fe₂O₃ nano-particles increases the deposition rate to 0.1 μm/minute. This may lead to more efficient manufacturing or fabrication process.

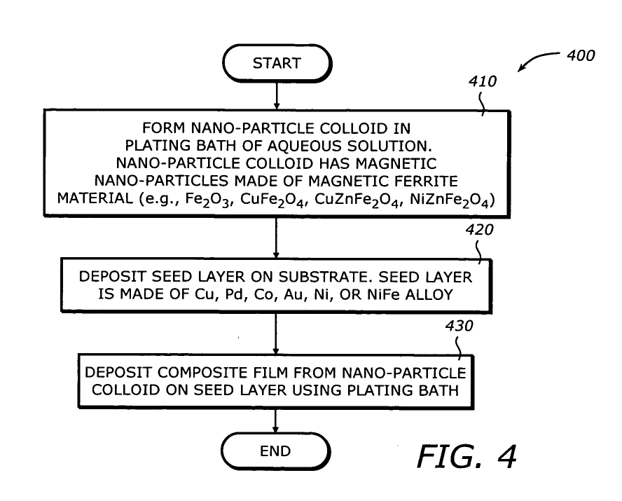

FIG. 4 is a flowchart illustrating a process 400 to fabricate an inductor according to one embodiment of the invention.

Upon START, the process 400 forms a nano-particle colloid in a plating bath of aqueous solution (Block 410). The nano-particle colloid has magnetic nano-particles made of magnetic ferrite material such as Fe₂O₃, CuFe₂O₄, CuZnFe₂O₄, or NiZnFe₂O₄, or any other suitable ferrite material.

Next, the process 400 deposits a seed layer on a substrate (Block 420). The seed layer may provide an initiation source for the electroless plating or electrical contact for the electro-plating. The seed layer may be made of a suitable material such as Cu, Pd, Co, Au, Ni, or NiFe alloy. Then, the process 400 deposits a composite film containing the magnetic nano-particles on the seed layer using the plating bath in a plating process (Block 430). The process 400 is then terminated.

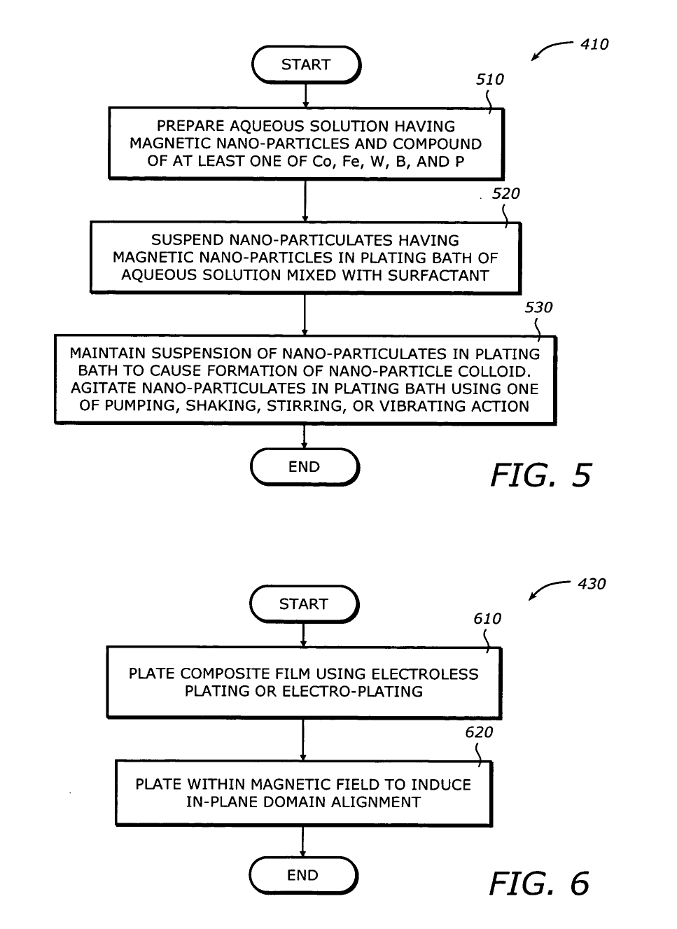

FIG. 5 is a flowchart illustrating the process 410 shown in FIG. 4 to form a nano-particle colloid according to one embodiment of the invention.

Upon START, the process 410 prepares the aqueous solution having the magnetic nano-particles and a compound of at least one of Co, Fe, W, B, and P (Block 510). Next, the process 410 suspends nano-particulates having the nano-particles in the plating bath of the aqueous solution mixed with a surfactant (Block 520). The surfactant helps suspending the nano-particulates. The surfactant may be a long chain polymer surfactant component, a short chain fatty acid surfactant component, or a combination of both. Long chain surfactants may be organic or inorganic. Examples of the surfactant are tyloxapol (or superinone or triton), p-isononylphenoxypoly (glycidol) also known as Olin-10G or Surfactant 10-G.

Then, the process 410 maintains suspension of the nano-particulates in the plating bath to cause formation of the nano-particle colloid (Block 530). This may be performed by agitating the nano-particulates in the plating bath using one of a pumping, shaking, stirring, or vibrating action. The process 410 is then terminated.

FIG. 6 is a flowchart illustrating the process 430 shown in FIG. 4 to deposit a composite film according to one embodiment of the invention.

Upon START, the process 430 plates the composite film using an electroless plating or an electro-plating with the plating bath (Block 610). The plating may be performed within a magnetic field to induce in-plane domain alignment (Block 620). The process 430 is then terminated.

As an example to illustrate the plating bath formulation, for an electroless CoWBP—Fe₂O₃ composite, the aqueous solution may contain the following compositions:
[Co²⁺]=0.01-0.05M
[citrate]=0.1-0.5M
[WO₄²⁻]=0.001-0.5M
[BO₃³⁻]=0.5-1.0M
[ammonium hypophosphite]=0.02-0.1M
[dimethylamineborane]=0.02-0.1M
surfactant=S10G, with concentration of 50-200 ppm
Fe₂O₃ nanopowder: <25 nm diameter, with solution loading of 0.05-1 g/L
pH=8.3-9.7
Temperature=60° C.-80° C.

Table 1 shows a comparison between the electroless CoWBP and electroless CoWBP with Fe₂O₃.

TABLE 1

| Film | CoWBP | CoWBP with Fe₂O₃ |
|---|---|---|
| Deposition rate (μm/min.) | 0.02 | 0.1 |
| Resistivity (μΩ · cm) | 140 | 40,000 |

Table 1 shows that the composite film with Fe₂O₃ nano-particles significantly increases the resistivity and the deposition rate compared to the non-composite film (i.e. without the Fe₂O₃ nano-particles).

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
forming a nano-particle colloid in a plating bath of an aqueous solution, the nano-particle colloid having magnetic nano-particles made of a magnetic ferrite material;
depositing a seed layer on a substrate; and
depositing a composite film containing the magnetic nano-particles on the seed layer using the plating bath.

2. The method of claim 1 wherein forming the nano-particle colloid comprises:
suspending nano-particulates having the magnetic nano-particles in the plating bath of the aqueous solution mixed with a surfactant; and
maintaining suspension of the nano-particulates in the plating bath to cause formation of the nano-particle colloid.

3. The method of claim 1 wherein the magnetic ferrite material is one of Fe₂O₃, CuFe₂O₄, CuZnFe₂O₄, and NiZnFe₂O₄.

4. The method of claim 1 wherein the magnetic nano-particles have diameter less than 100 nm.

5. The method of claim 1 wherein the seed layer is made of Cu, Pd, Co, Au, Ni or NiFe alloy.

6. The method of claim 1 wherein forming the nano-particle colloid further comprises:
preparing the aqueous solution having the magnetic nano-particles and a compound of at least one of Cobalt, Iron, Tungsten, Boron, and Phosphorus.

7. The method of claim 1 wherein depositing the composite film comprises:
plating the composite film using an electroless plating or an electro-plating.

8. The method of claim 1 wherein plating the composite film further comprises:
plating the composite film within a magnetic field to induce in-plane domain alignment.

9. The method of claim 2 wherein maintaining suspension comprises:
agitating the nano-particulates in the plating bath using one of a pumping, shaking, stirring, or vibrating action.

10. A device comprising:
a substrate;
a seed layer deposited on the substrate; and
a composite film plated on the seed layer, the composite film having magnetic nano-particles made of a magnetic ferrite material.

11. The device of claim 10 wherein the magnetic ferrite material is one of Fe₂O₃, CuFe₂O₄, CuZnFe₂O₄, and NiZnFe₂O₄.

12. The device of claim 10 wherein the magnetic nano-particles have diameter less than 100 nm.

13. The device of claim 10 wherein the seed layer is made of Cu, Pd, Co, Au, Ni, or NiFe alloy.

14. The device of claim 10 wherein the magnetic nano-particles have diameter less than 100 nm.

15. The device of claim 10 wherein the composite film has a resistivity of more than 20,000 μΩ·cm.

16. The device of claim 10 wherein the composite film has an eddy current loss of less than 1%.

17. A system comprising:
a front end processing unit to receive and transmit a radio frequency (RF) signal, the RF signal being converted to digital data; and
a voltage regulator to regulate supply voltage to the front end processing unit, the voltage regulator comprising a feedback circuit having an inductor circuit, the inductor circuit comprising:
a substrate,
a seed layer deposited on the substrate, and
a composite film plated on the seed layer, the composite film having magnetic nano-particles made of a magnetic ferrite material.

18. The device of claim 17 wherein the magnetic ferrite material is one of Fe₂O₃, CuFe₂O₄, CuZnFe₂O₄, and NiZnFe₂O₄.

19. The device of claim 17 wherein the magnetic nano-particles have diameter less than 100 nm.

20. The device of claim 17 wherein the seed layer is made of Cu, Pd, Co, Au, Ni, or NiFe alloy.

21. The device of claim 17 wherein the magnetic nano-particles have diameter less than 100 nm.

22. The device of claim 17 wherein the composite film has a resistivity of more than 20,000 μΩ·cm.

23. The device of claim 17 wherein the composite film has an eddy current loss of less than 1%.
